(19) United States
(12) Patent Application Publication
(10) Pub. No.: US 2016/0229397 A1
(43) Pub. Date: Aug. 11, 2016

(54) SMART ACTIVE ADAPTIVE AUTONOMOUS SHORT DISTANCE MANOEUVRING & DIRECTIONAL WARNING SYSTEM WITH OPTIMAL ACCELERATION FOR AVOIDING OR MITIGATING IMMINENT & INEVITABLE SIDE IMPACT AND REAR END COLLISION

(71) Applicant: PRASAD MUTHUKUMAR, Tamil Nadu (IN)

(72) Inventor: PRASAD MUTHUKUMAR, Tamil Nadu (IN)

(21) Appl. No.: 15/021,702

(22) PCT Filed: Sep. 15, 2014
(86) PCT No.: PCT/IN2014/000595

§ 371 Date: Mar. 15, 2016

(30) Foreign Application Priority Data
Sep. 18, 2013 (IN) 4177/CHE/2013

(51) Int. Cl. B60W 30/09; B60Q 9/00; G05D 1/00; G01S 19/13; B60W 10/20; B60W 10/04

(52) U.S. Cl. CPC B60W 30/09; B60W 10/20; B60W 10/04; G05D 1/0088; G01S 19/13; B60Q 9/008; B60W 2550/10; B60W 2420/52; B60W 2520/28; B60W 2520/10

(57) ABSTRACT

Autonomous short distance manoeuvring with optimal acceleration for avoiding or mitigating inevitable side and read end collision is a highly time sensitive design and technique that actively monitors, instantaneously senses inevitable or imminent side impact and rear end collision, alert or warns the driver and if the driver not available or doesn't react or if the drivers sensing and reaction time is not sufficient the present system according to scenarios acts in the right time to takes control of the vehicle's with autonomous optimal acceleration and steering followed by deceleration or restoring the control back to driver based on scenarios thereby mobilising the vehicle to short distance according to critical situations thus efficiently utilising the space around the vehicle to manoeuvre, locate or position the vehicle ultimately to avoid or mitigate the side impact and read end collision. The present system particularly helps in efficiently utilising the space or environment around the vehicle in critical situations ultimately to avoid or mitigate Imminent and inevitable side impact and rear end collision. The system smartly senses, perform context aware computing in a closed loop processing manner thereby autonomously and optimally accelerate and steer the vehicle to right position ultimately to avoid or reduce the side and read end collision thus assist in overcoming or mitigating critical situations for protecting the vehicles, occupants, pedestrians and other objects around or on the way. Also according to design, configurations and scenarios the system instantaneously restores or transfers the control back to the driver after the vehicle overcomes the critical situation or restores the vehicle position. In critical situations SAAAMS performs sensing, warns or alerts, performs pre computing & set ready to control the vehicle's acceleration prior to critical situation, current computing for controlling the vehicle's acceleration during critical situation, post computing to either stop or transfer the control back to the driver after overcoming the critical situation all accordingly to design, configuration and scenarios. The present system utilise smart and adaptive closed loop processing algorithm with predetermined and tested correlation table parameters to instantaneously check and compare the effects between predetermined and tested real world scenarios to the actual real world scenarios for actively sensing, computing and controlling the vehicle accordingly to mitigate the critical situations. In case of vehicles available in both front and rear end and if the rear end vehicle is about to collide the system actively senses, instantaneously manoeuvre the vehicle ultimately to efficiently utilises the space available between the own vehicle and front end vehicle thereby to provide space for the rear end vehicle that is about to collide to either stop or in extreme situations mitigates the severity of the collision.

### FIELD OF INVENTION

The present invention is related to automobile or transportation safety domain and more particularly into vehicles side and read end collision -avoiding and mitigation system.

### OBJECTIVE

The primary aim of our present invention is to efficiently utilise the space around the vehicle for short distance manoeuvring through autonomous acceleration based on sensing environmental conditions thereby to provide space and time for other vehicle to react and utilise ultimately to avoid or mitigate the imminent and inevitable side impact and rear end collision.

### HIGHLIGHTS

Imminent and Inevitable Side impact avoiding and mitigation system through optimal acceleration.
Imminent and Inevitable Rear end Collision avoiding and mitigation system through optimal acceleration.
Directional warning system for Imminent and Inevitable side impact and rear end collision

### BACKGROUND AND PROBLEM STATEMENT

Some accidents happen during vehicle in motion and even some accidents happen when the vehicle is stationary. Automatic Breaking can help in avoiding collision but to some extents and there are exceptions. Actually vehicles travelling in high speeds need adequate stopping space which won't be available all the time. Even though feasibility and space are available to the vehicle in stationary or motion these feasibility and space are not utilised to full potential ultimately to avoid or mitigate the accident. The road and whether conditions affect these sensor systems which in turn lead to reducing the reaction time to take preventive measures. Actually there are collision scenarios where the driver's sensing and reaction time cannot match up with the critical situations [E.g. Collision that happens in road intersections, traffic, and vehicle parked in highway road side]. Even when the driver sense, react and manoeuvre to locate or position and mobilise the vehicle, due to inaccuracy and time sensitiveness of the critical scenario the precision levels to avoid or mitigate the critical satiations are not sufficient. According to the National Highway Traffic Safety Administration, 40% of all traffic accidents occur in intersections where side-impact collisions are most common and Rear-end collision constitutes to approximately 25% to 32% accidents. Lot side impact collisions are most common and happen in intersections which are highly time sensitive.

Some companies are utilising automatic breaking systems for avoiding and mitigating the front end inevitable or imminent collision with respect their own vehicle. More importantly in the real world still not all the vehicles are equipped the automatic breaking system and every time we cannot expect the rear end vehicle to automatically break in case of in evitable collision. There are scenarios where the rear end vehicle even with automatic breaking system cannot completely avoid colliding with the preceding vehicle. Even with automatic breaking system there are exceptions and scenarios where some imminent collision occur due to—Radars performance affected by whether or environmental conditions [Rain, Snow etc] which in turn reduces the sensing time, vehicle breaking reaction time, Vehicle speed, Vehicle breaking efficiency, Tire conditions, Road conditions [Wet versus Dry], Road surface Compositions etc which are all can reduces sensing and reaction time of the whole automatic breaking systems which in turn leads to inevitable collision due to very high time and space sensitiveness. So as a whole we can not only depend on automatic breaking system to avoid or mitigate collision. Even though feasibility and space are available to the vehicle in stationary or motion these feasibility and space are not utilised to full potential ultimately to avoid or mitigate the accident.

Already some companies in the automobile industry have started utilising side impact and rear end collision sensing cameras and radars to activate seat belt pretensioners, airbags and whiplash protection systems in the right time. But these systems can only sense to reduce the severity of the collision and none of the systems can actively manoeuvre the vehicle to avoid or mitigate inevitable rear end collision and side impact.

### SUMMARY

Actually accidents and collisions are highly time and space sensitive. During an imminent and inevitable collision the environment and space around the vehicle plays an important role in avoiding and mitigating side impact and rear end collision of the vehicles. So the whole aim of the system is to efficiently utilise the space around the vehicle in case of critical situations to avoid or mitigate inevitable or imminent collision.

During critical situations the present system efficiently utilise the space around the vehicle through instantaneous and autonomous short distance manoeuvring with optimal acceleration & steering based on actively sensing environmental conditions thereby to provide space and time for other vehicle to react and utilise ultimately to avoid or mitigate the imminent and inevitable side impact and rear end collision. Initially the system warns the driver with visible and audible alert regarding imminent side and rear end collision and if the driver doesn't react on time the system autonomously manoeuvres the vehicle accordingly. Actually there are collision scenarios where the driver's sensing and reaction time cannot match up with the critical situations [E.g. Collision that happens in road intersections, traffic, and vehicle parked in highway road side]. Even when the driver sense, react and manoeuvre to locate or position and mobilise the vehicle, due to inaccuracy and time sensitiveness of the critical scenario the precision levels to avoid or mitigate the critical satiations are not sufficient. So the present system takes control of these situations and once the vehicle overcomes the critical situations the present system actively transfers the vehicle control back to the driver. The system take control to manoeuvre the vehicle in right time with right speed in right direction and either stops or continue with motion according to scenarios and transfers the control back to driver.

According to one aspect of present invention when the system detects a imminent or inevitable side impact, alerts and accordingly autonomously manoeuvre the vehicle to short distance through optimal acceleration and steering thereby to provide space and time for colliding vehicle to reach and utilise ultimately to avoid or mitigate side impact.

According to one aspect of present invention when the system detects a imminent or inevitable rear end collision, alerts and accordingly autonomously manoeuvre the vehicle to short distance through optimal acceleration thereby to provide space and time for rear end vehicle to reach and utilise ultimately to avoid or mitigate rear end collision.

According to another aspect the Smart Manoeuvre acts in inevitable rear end collision thereby manoeuvres the vehicle accordingly with available space to providing space for side and rear end vehicle to react and utilise ultimately to avoid or mitigate rear end collision

According to another aspect the present system provides directional audible and visible warning regarding inevitable or imminent side impact and rear end collision.

According to another aspect of the present system in an imminent rear end collision the same optimal acceleration is utilised to avoid or mitigate the collision with pedestrians in front of the vehicle by automatically warns and optimally accelerating the vehicle thereby providing time for the pedestrians to react and in extreme scenarios allows the vehicle to collide the pedestrians with minimal impact ultimately reducing the severity of the accident.

### DETAILED DESCRIPTION

During an imminent and inevitable collision the environment and space around the vehicle plays a very important role in avoiding and mitigating side impact and rear end collision of the vehicles. So the whole aim of the system is to efficiently utilise the space around the vehicle in case of critical situations to avoid or mitigate inevitable or imminent collision through optimal acceleration. In critical situations the present system efficiently utilise the space around the vehicle through instantaneous and autonomous short distance manoeuvring with optimal acceleration & steering based on actively sensing environmental conditions thereby to provide space and time for other vehicle to react and utilise ultimately to avoid or mitigate the imminent and inevitable side impact and rear end collision. The system smartly senses, perform context aware computing in a closed loop processing manner and directing the vehicle through optimal acceleration and steering the vehicle in right direction ultimately to avoid or reduce the impact of collision and to overcome or mitigate critical situations for protecting the vehicles, occupants, pedestrians and other objects around or on the way. Also according to design, configurations and scenarios the system instantaneously restores or transfers the control back to the driver after the vehicle overcomes the critical situation. In critical situations SAAAMS performs sensing, warns or alerts, performs pre computing & set ready to control the vehicle prior to critical situation, current computing for controlling the vehicle during critical situation, post computing to either stop or transfer the control back to the driver after overcoming the critical situation all accordingly to design, configuration and scenarios. The present system utilise smart and adaptive closed loop processing algorithm with predetermined and tested correlation table parameters to instantaneously check and compare the effects between predetermined and tested real world scenarios to the actual real world scenarios for actively sensing, computing and controlling the vehicle accordingly to mitigate the critical situations. In case of vehicles available in both front and rear end and if the rear end vehicle is about to collide the system actively senses, instantaneously manoeuvre the vehicle ultimately to efficiently utilises the space available between the own vehicle and front end vehicle thereby to provide space for the rear end vehicle that is about to collide to either stop or in extreme situations mitigates the severity of the collision.

The present safety system concept can be achieved with minimum or nearly zero hardware requirements and with enhancement to the existing coding or software that can easily be adopted with vehicles existing onboard computer. The system utilise already available radar and camera system to sense the environment around the vehicle. So either minimum or no dedicated hardware is required for implementation [No dedicated environment sensing system required as our present system utilises vehicles existing radar's or cameras or sensor system for its own operation].

Minimum or no dedicated alerting and warning systems required [Like visible and audio devices as our present system utilises vehicles existing lights, user interface, horn and audio systems to alert and warn the occupants inside the vehicle]

Minimum or No dedicated processing unit for computation is required, As our present system utilises vehicles onboard computer to actively perform computing and alerting the occupants

Minimum or No dedicated software requirement, as our present system works by just enhancing the existing vehicles onboard computers program or software which is sufficient to achieve this safety system.

The system works irrespective of driver or occupants available in the inside vehicle according to drivers requirement. When enabled the system even works without driver available inside the vehicle for either protecting the occupants inside the vehicle.

This feature can be used with hazardous light, releasing breaking system like parking or hand break etc, audible and visible warning inside and around the vehicle. lights and audio devices to automatically alerts or warns the impending vehicles.

The system actively takes control from the driver whether the driver intentional or unintentionally trying to make an accident according to design, configuration and scenarios. Provides safety for both vehicle in motion and stationary or parked. This feature mainly helps in highways where the vehicle are parked on the road side. The system even works when the car is parked or hazardous light is enabled. The system works irrespective of whether the vehicle is on or off and works only based on sensing the occupants inside the vehicle. According to configuration the system can be made to turn off for vehicles parked or long time, and can be made to turn on automatically based on pre configurations.

### Hardware and Functionality

a) Sensors—Vehicles existing radars and cameras utilised by SAMS for scanning and sensing the vehicle environment [Autonomous cruise control, Automatic breaking, Self Parking Systems etc which are all already utilised for scanning and sensing the vehicles environment in 360 degrees]

b) Power Source—Existing Vehicle power source can be utilised for SAMS operations.

c) Communication System—Existing vehicle communication system architecture can be utilised for SAMS signaling and operation.

d) On Board Computer & Processing unit—Vehicle's existing onboard computer can be utilised by SAMS for actively monitoring critical scenarios. Collecting required parameters, centralised processing and instantaneously accelerate and steer the vehicle according to critical situations.

e) Software or Programming—Vehicles onboard computers existing software or programs can be enhanced and utilised for the operation of SAMS.

f) Vehicle Control Systems—SAMS utilises Vehicles existing Accelerator, Steering Control System [STS], Clutch, Gear, Break etc

When the system detects an inevitable side impact or rear end collision, alerts the drive and occupants regarding the same. Even after alerting the driver regarding imminent rear end collision if the driver doesn't respond the system itself will autonomously manoeuvre the vehicle for avoiding or mitigating the inevitable or imminent side impact and rear end collision with vehicles motion, directions, distance, breaking and stopping are all with the whole system that works based on actively sensing the feasibilities and parameters comprising of sensing vehicle surrounding or environment [utilising already available radars & cameras], space around the vehicle [front and side], sensing impending or inter vehicular and other objects approaching and relative speed, distance, position, orientation, road or terrain condition, and vehicle current status with respect to its own vehicle, location, positioning systems [GPS], active terrain and road condition sensing, occupants or passenger status, pedestrian status, monitors the driver input parameters, engine parameters, tires position or angle of attack, load & torque distribution, tire traction, steering wheel position, cornering effects, change in Centre of gravity, over & under steering and interacting with vehicle safety and stability systems like ABS, EBD, ESC, TCS, Rollover mitigation systems, ECU, BA, Precrash systems, suspension & vertical dynamics, radar assisted auto breaking, cruise control system, aerodynamics & airbrakes etc to compute the control signal ultimately to avoiding or mitigating the accident and in extreme cases thereby reduces the impact of collision to protect the occupants, vehicles and other objects around or on the way. Smart manoeuvre acts in critical situations when the system detects a possible collision between stationary vehicle and vehicle in motion.

When the system detects an inevitable side impact or collision the system according to scenarios either autonomously steers, accelerate and decelerate or break [based on preceding and rear vehicles availability, distance, speed & status] to position the vehicle in optimised location or mobilise ultimately to avoid the collision and in extreme scenarios of imminent side impact the present system makes sure that the impending vehicle does not collide with the vehicle's passenger safety cage or cell. The whole system works based on sensing inter vehicular and other objects in the environment with its approaching and relative—speed, distance, direction, position, orientation, road or terrain condition, and vehicle's current status

Sensing the environment and automatically, if the driver doesn't react or not available to move the vehicle accordingly to avoid of reduce the impact of collision and simultaneously restores the control to stop the vehicle in optimum position. The system even restores the vehicle position back to parked space. In an inevitable collision the impact of vehicle colliding with rear end of stationary vehicle is very high when compared with vehicle in motion. Our present system works in these scenarios to avoid collision or in extreme critical scenarios highly mitigates the severity of collision by reducing the impact.

In case of imminent rear end collision for stationary vehicle the present system manoeuvres the vehicle to a shorter distance like some half or 1 meter or more based on scenarios to avoid or mitigate the collision according design, configuration and scenarios and then once again the present system breaks and stops the vehicle [This operation can be configured to operate only once and will be activated to operate again only after the driver accelerates or presses the gas pedal to once again operate.

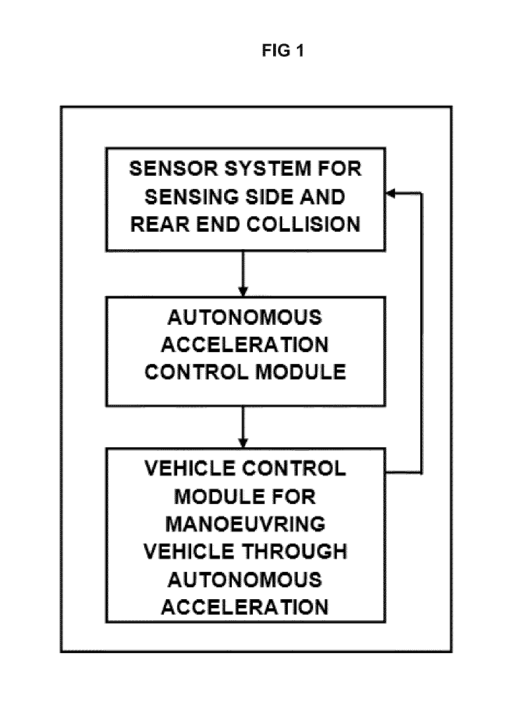

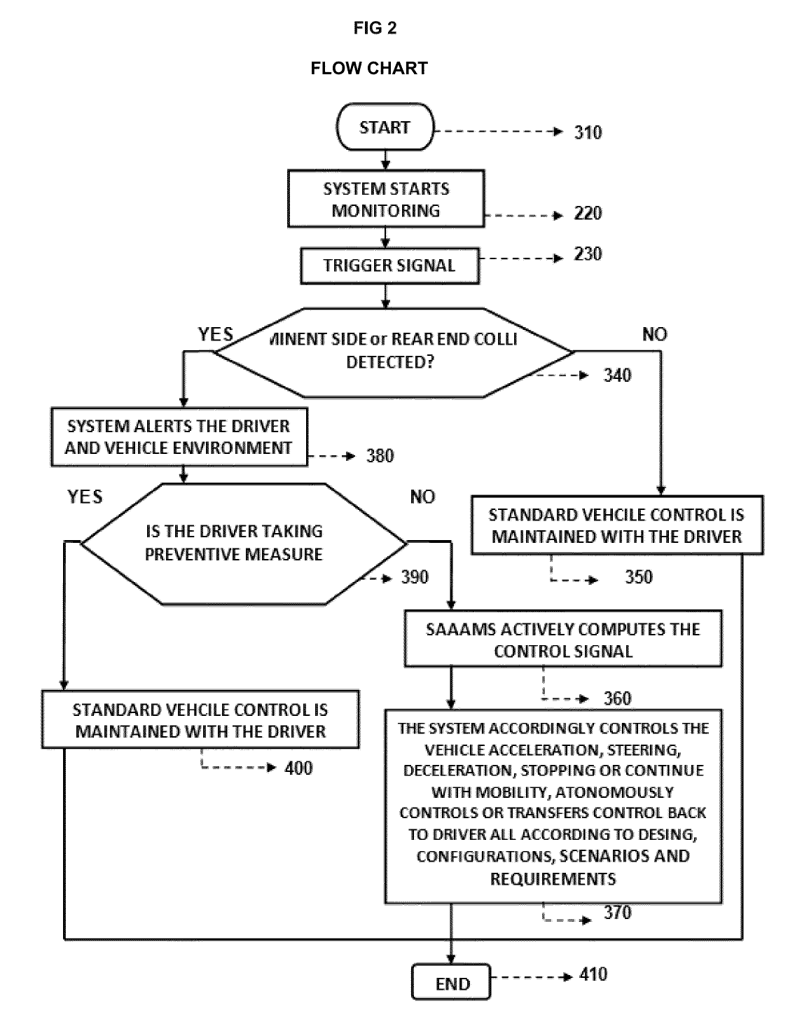

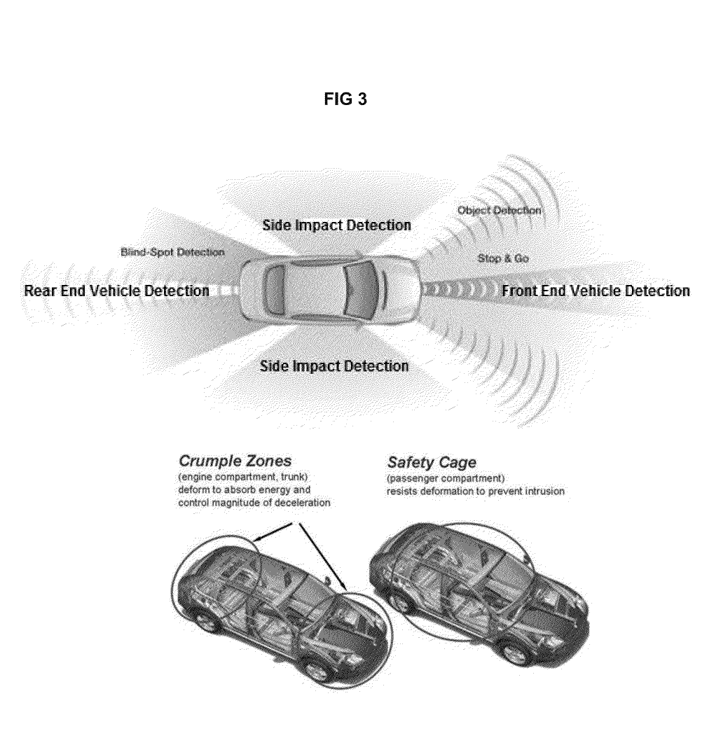

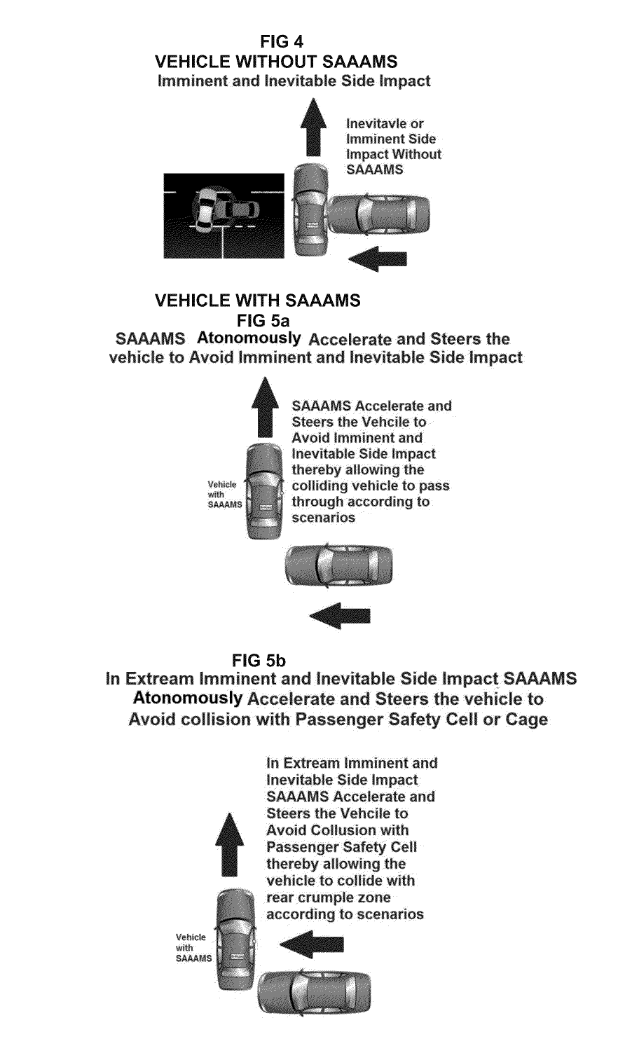

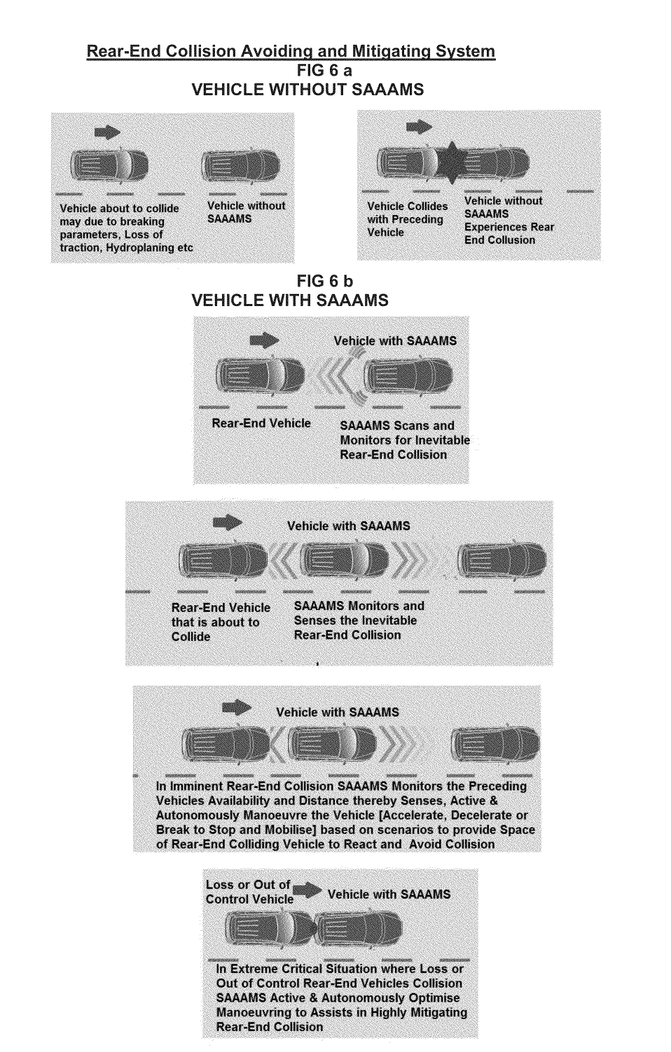

FIG. 6 a&b

The Rear End Collision avoiding/mitigating system already available is completely focused on automatic breaking system that only applies break automatically & accordingly to prevent collision or minimize the severity of collision particularly with respect to rear end of—preceding vehicle A [vehicle in front A]. Here I am not focused on—collusion of vehicle B with rear end of vehicle A which is already available and I am aware of its availability.

Let us assume

A—Preceding Vehicle or Front End vehicle. Where vehicle A is preceding vehicle B

B—Present Vehicle with SAAAMS Protection System

C—Rear End Vehicle or Vehicle Behind. About to collide vehicle C which is following vehicle B

But our present system is about vehicle B & C and particularly focused on collision avoiding/mitigating in rear end of vehicle B [with SAAAMS] with respect to following & about to collide rear end vehicle C [and not on the vehicle A which is in front of vehicle B]. Also more particularly other systems only focused on and starts with automatic breaking parameters and not on acceleration to mobilize the vehicle. However our present system in case of imminent rear end collision actually focused on “OPTIMAL ACCELERATION” [based on vehicle B's front space availability] and particularly starts with initial acceleration and mobilizing of vehicle B thereby providing space & time for colliding rear end vehicles C to react, break, stop and utilize [for avoiding collision and in extreme scenarios mitigating the severity of vehicle B's rear end collision] then automatic breaks are applied based on “Availability” of preceding vehicle A with its relative distance, speed etc [to prevent collision with vehicle A] else transfers the vehicle control back to driver for further manoeuvring. Please have a check with the diagrams in page number 9 of already sent document for further information and kindly let me know your views.

### Feasibility, Hardware, Compatibility and Interoperability with Existing Systems

The present SAAAMS safety concept can be achieved with minimum or nearly zero hardware requirements and with enhancement to the existing coding or software that can easily be adopted with vehicles existing onboard computer. The system utilise already available radar and camera system to sense the environment around the vehicle. So either minimum or no dedicated hardware is required for implementation [No dedicated environment sensing system required as our present system utilises vehicles existing radar's or cameras or sensor system for its own operation].
Vehicles existing radars and cameras are utilised by SAAAMS for scanning and sensing the vehicle environment [as Autonomous cruise control, Automatic breaking, Self Parking Systems etc which are all the features the already utilises scanning and sensing the vehicles environment in 360 degrees that comprises of long range, intermediate range and short range radars for scanning the environment].
Minimum or No dedicated processing unit for computation is required, As our present system utilises vehicles onboard computer to actively perform computing and alerting the occupants
Minimum or No dedicated software requirement, as our present system works by just enhancing the existing vehicles onboard computers program or software which is sufficient to achieve this safety system.
The system can be configured to work irrespective of driver or occupants [all combinations of drivers and occupants availability and not available] available in the inside vehicle according to scenarios. When enabled the system even works without driver available inside the vehicle for either protecting the occupants inside the vehicle.
Minimum or no dedicated alerting and warning systems required [Like visible and audio devices as our present system utilises vehicles existing lights, user interface, horn and audio systems to alert and warn the occupants inside the vehicle]
This feature can be used with hazardous light, releasing breaking system like parking or hand break etc, audible and visible warning inside and around the vehicle. Lights and audio devices to automatically alerts or warns the impending vehicles.
The system actively takes control from the driver whether the driver intentional or unintentionally trying to make an accident according to design, configuration and scenarios. Provides safety for both vehicle in motion and stationary or parked. This feature mainly helps in highways where the vehicle are parked on the road side. The system even works when the car is parked or hazardous light is enabled. The system works irrespective of whether the vehicle is on or off and works only based on sensing the occupants inside the vehicle. According to configuration the system can be made to turn off for vehicles parked or long time, and can be made to turn on automatically based on pre configured settings.

### Warning System

Warning system alerts with directional audible and visible warning utilising vehicles existing or available and dedicated lighting system and sounding devices like horn or speaker system. Radar based warning system -When the front rear or side pedestrian, vehicle and objects approaching at high speeds the system automatically sense and trigger the lighting system and horn ultimately to alert the real vehicle to mitigate or avoid rear end collision and whiplash injuries. The system even helps in alerting the driver & passengers inside the vehicle about the possible collision which in turn aids them to act accordingly to overcome or mitigate the critical situation. The system also alerts with the passenger inside and outside the vehicle with audible and visible warnings. Utilising dynamic directional horn the sound is focused in the right direction to avoid unnecessary disturbances.

The embodiments of the present invention is not limited to listed scenarios described here or its combinations and the above presented are just examples. There may be other scenarios and those who skilled in field can understand and modify, enhance, alter the herein system without departing from the scope of the invention in its widest form.

1. Autonomous Optimal Acceleration based Short Distance Manoeuvring & Warning System for Avoiding or Mitigating Imminent & Inevitable Side Impact and Rear End Collision comprises of
a. A sensor system for actively monitoring, sensing and generating trigger signal by detecting the critical situations of vehicle comprising of side and rear end collision.
b. A processing unit which is highly time sensitive design and technique with high processing and functioning speeds that actively sense imminent or inevitable side impact and rear end collision irrespective of vehicle status whether in stationary or in motion thereby controls the vehicle through autonomous manoeuvring particularly with optimal acceleration and steering ultimately to mobilise the vehicle to right position thereby providing space and time for other colliding vehicle to react and utilise eventually to avoid or mitigate side and rear end collision ultimately to protect the occupants, vehicles, pedestrians and other things around & on the way.
c. After overcoming the critical situations the present system accordingly to scenarios either transfers the control back to driver or decelerates or restores the previous vehicle position.
d. In an imminent rear end collision the same optimal acceleration is utilised to avoid or mitigate the collision with pedestrians in front of the vehicle by automatically warns and optimally accelerating the vehicle thereby providing time for the pedestrians to react and in extreme scenarios allows the vehicle to collide the pedestrians with minimal impact ultimately reducing the severity of the accident.
e. The system performs active monitoring & sensing, pre computing & set ready to accelerate and control the vehicle prior to critical situation, current computing for accelerating and controlling the vehicle during critical situation, post computing to restore the vehicle control status after overcoming the critical situation.
f. The system utilise smart and adaptive closed loop processing algorithm with predetermined and tested correlation or lookup table to instantaneously check and compare the effects between predetermined and tested real world scenarios and parameters with the actual real world scenarios for smart & actively sensing, computing and controlling the vehicle through optimal acceleration to avoid or mitigate side and rear end collision.

2. The system said in claim 1, comprise of sensor system that works based on one or combination of sensors, safety & stability parameters, configurations, operating modes and usage scenarios for sensing and detecting side and read end collision and utilise it for pre computing & set ready to accelerate the vehicle, current computing for accelerating and controlling the vehicle during critical situation and post computing to restore the control back to driver or restore the vehicle position after critical situation ultimately to overcome and mitigate the side and rear end collision. Sensors for sensor system comprise of
a. Vehicle speed and wheel speed sensor for sensing the vehicle speed and wheels speed thereby utilising it for computing in critical situations.
b. Radar and range sensors for scanning the environment around the vehicle by detecting vehicles, pedestrians and objects in front, rear and around the vehicle with its direction, dimension, distance, nature, approaching & departing speed with respect the vehicle thereby utilised for pre, current and post computing ultimately utilising it for controlling the tire pressure according to critical situation. The radar system comprises of visual, active and passive infrared cameras with real-time digital image and signal processing thereby to sense the nature of the objects around the vehicle.
c. Orientation sensors and accelerometer for sensing the vehicles orientation, acceleration and deceleration thereby utilising it for computing the tire pressure accordingly in critical situations.
d. Load sensor for sensing the load of the vehicle, load on individual wheel tires and change in centre of gravity thereby utilising it for computing the tire pressure accordingly in critical situations.
e. Steering angle or position sensor for sensing the position of the steering wheel and vehicles relative motion thereby sensing vehicle stability, over and under steering ultimately utilising it for computing the tire pressure accordingly in critical situations.
f. Break force sensor for sensing the nature of the break force during breaking scenarios ultimately utilising it for pre computing, current computing and post computing thereby to control the tire pressure accordingly in critical situation.
g. Terrain, road or contact area sensors for sensing the nature of present contact and impending road and terrain surfaces with its property comprising of normal dry roads, wet, mud & ruts, rocks, gravel, grass, snow, sand, rough, highly uneven terrain, rocky crawl and its combinations thereby utilise it computing the tire pressure accordingly in critical situations.
h. GPS sensors for predicting the turns, curves and bends ahead of the road for pre computing and set ready for controlling the tire pressure accordingly.
i. The system utilizes predetermined and tested field mapping or correlation or lookup table for sensing, comparing & matching the effects between real time sensor system parameters with predetermined and tested sensor system parameters ultimately for computing the tire pressure accordingly.
j. The sensor systems precision levels, sensing depth of dimension and multi layer sensing are utilised according the design & requirement. The sensor system utilise sensors, capable of either fixed or tuneable sensitivity and the range are selected according to design, configuration, scenarios and requirement.

3. The system said in claim 1, utilise correlation or lookup tables to actively check and compare the effects caused in actual real world scenarios with predetermined and tested real world scenarios to autonomously accelerate and steer accordingly in critical situations.

4. The system said in claim 1, where in an imminent rear end collision the same optimal acceleration is utilised to avoid or mitigate the collision with pedestrians in front of the vehicle by automatically warns and optimally accelerating the vehicle thereby providing time for the pedestrians to react and in extreme scenarios allows the vehicle to collide the pedestrians with minimal impact ultimately reducing the severity of the accident.

5. The system said in claim 1, where the warning system alerts with directional audible and visible warning utilising vehicles existing or available and dedicated lighting system and sounding devices like horn or speaker system. Radar based warning system -When the front rear or side pedestrian, vehicle and objects approaching at high speeds the system automatically sense and trigger the lighting system and horn ultimately to alert the real vehicle to mitigate or avoid rear end collision and whiplash injuries. The system even helps in alerting the driver & passengers inside the vehicle about the possible collision which in turn aids them to act accordingly to overcome or mitigate the critical situation. The system also alerts with the passenger inside and outside the vehicle with audible and visible warnings. Utilising dynamic directional horn the sound is focused in the right direction to avoid unnecessary disturbances.
